(19) United States
(12) Patent Application Publication
(10) Pub. No.: US 2025/0060481 A1
(43) Pub. Date: Feb. 20, 2025

(54) IMAGE AND LIDAR ADAPTIVE TRANSFORMER FOR FUSION-BASED PERCEPTION

(71) Applicant: QUALCOMM Incorporated, San Diego, CA (US)

(72) Inventors: Meysam Sadeghigooghari, Linkoping (SE); Varun Ravi Kumar, San Diego, CA (US); Senthil Kumar Yogamani, Headford (IE)

(21) Appl. No.: 18/452,279

(22) Filed: Aug. 18, 2023

(51) Int. Cl. G01S 17/86; B60W 50/14; G06T 7/50; G06T 17/00; G06V 10/25; G06V 10/44; G06V 10/80; H04N 19/597

(52) U.S. Cl. CPC G01S 17/86; B60W 50/14; G06T 7/50; G06T 17/00; G06V 10/25; G06V 10/44; G06V 10/806; H04N 19/597

(57) ABSTRACT

An apparatus includes a memory and processing circuitry in communication with the memory. The processing circuitry is configured to apply, based on a positional encoding model, a first feature conditioning module to a set of bird's eye view (BEV) position data features corresponding to position data to generate a set of conditioned BEV position data features, and apply, based on the position encoding model, a second feature conditioning module to a set of perspective image data features corresponding to image data to generate a set of conditioned perspective image data features. The processing circuitry is also configured to generate, based on the positional encoding model, the set of conditioned BEV position data features, and the set of conditioned perspective image data features, a weighted summation. Additionally, the processing circuitry is configured to generate, based on the weighted summation, a set of BEV image data features.

### TECHNICAL FIELD

This disclosure relates to sensor systems, including sensor systems for advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include a Light Detection and Ranging (LiDAR) system or other sensor system for sensing point cloud data indictive of the existence and location of other objects around the autonomous driving vehicle. In some examples, such an autonomous driving vehicle may be referred to as an ego vehicle. A vehicle having an advanced driver-assistance systems (ADAS) is a vehicle that includes systems which may assist a driver in operating the vehicle, such as parking or driving the vehicle.

### SUMMARY

The present disclosure generally relates to techniques and devices for generating bird's eye view (BEV) image data features based on image data and position data to account for an importance of image data and position data for generating an output. For example, a system may extract a set of features from image data and a set of features from position data. The system may generate a first set of BEV features based on the set of features extracted from the image data and generate a second set of BEV features based on the set of features extracted from the position data. In some examples, the system may fuse the first set of BEV features and the second set of BEV features to create a fused set of BEV features. The fused set of BEV features may be used for a wide variety of tasks including controlling an object (e.g., a vehicle or a robotic arm) within a three-dimensional (3D) environment, generating virtual reality (VR) and augmented reality (AR) content, or other tasks that use image segmentation, depth detection, or object detection.

A 3D environment may, in some examples, include one or more objects. For example, the 3D environment may include one or more moving objects (e.g., vehicles, animals, people), and one or more non-moving objects (e.g., traffic signs, road markers, trees, barriers, and fences). A system may collect image data and position data that includes information corresponding to one or more objects within the 3D environment. In some examples, the image data may include one or more camera images that indicate an appearance of the one or more objects. In some examples, the position data may be a point cloud generated by Light Detection and Ranging (LiDAR) system, where the point cloud includes points that indicate positions of the one or more objects.

BEV features include information corresponding to one or more objects within a 3D environment from a perspective above the one or more objects looking down at the one or more objects. Position data, in some examples, represents 3D data that indicates a shape of the one or more objects within the and/or a location of the one or more objects within the 3D environment. Image data may include information such as color, appearance, and shape of the one or more objects. To create the BEV features corresponding to position data, the system may compress 3D features extracted from the position data into a two-dimensional (2D) representation of the 3D environment. To create the BEV features corresponding to image data, the system may project features extracted from the image data onto a 2D representation of the 3D environment. Since features extracted from image data may indicate an appearance of one or more objects in the 3D environment from the perspective of a camera capturing the image data but do not necessarily indicate a location of the one or more objects, it may be beneficial to weigh an importance of appearance and an importance of location in generating the BEV features corresponding to image data.

Several factors may affect an importance of image data and an importance of position data collected by the system for generating BEV features. For example, when a 3D environment includes a traffic light at an intersection and a moving pedestrian approaching the intersection, and when the system is part of an advanced driver assistance system (ADAS) for controlling a vehicle within the 3D environment, image data and position data do not have the same importance for determining characteristics of the traffic light and characteristics of the moving pedestrian. That is, image data may be more important for determining the color of the stop light, because the color of the stop light is more useful for generating an output to control a vehicle within the 3D environment. Image data might not be as important for determining a color of the pedestrian's clothing, because clothing color is not dispositive for controlling the vehicle within the 3D environment. Position data may be important both for determining the location of the vehicle and determining the location of the stop light.

The techniques of this disclosure are not limited to processing position data and image data to control a vehicle. The system of this disclosure may be used to process position data and image data to generate an output for any purpose in a way that accounts for the relative importance of image data and the relative importance of position data to accomplish a task. By accounting for the relative importance of image data and the relative importance of position data in generating BEV features corresponding to image data, the system may generate BEV features that indicate more relevant information (e.g., appearance, identity, location, movement) corresponding to objects within a 3D environment.

The techniques of this disclosure may result in improved BEV features generated from image data and/or position data as compared with other systems that do not account for the relative importance of image data and position data for generating an output to accomplish a task. For example, the system may use feature conditioning modules to process BEV features generated based on features extracted from position data and process features extracted from image data. These feature conditioning modules may use a positional encoding model trained using sets of training data to identify patterns that indicate importance of position data for identifying characteristics of objects and patterns that indicate importance of image data for identifying characteristics of objects. This may allow the system to weigh the relative importance of image data and position data in generating a set of BEV features corresponding to image data. When the system fuses the BEV features corresponding to image data and the BEV features corresponding to position data, the fused set of BEV features may indicate more relevant information corresponding to each object of one or more objects as compared with systems that generate BEV features for image data without accounting for the relative importance of image data and position data.

In one example, an apparatus for processing image data and position data includes a memory for storing the image data and the position data; and processing circuitry in communication with the memory. The processing circuitry is configured to apply, based on a positional encoding model, a first feature conditioning module to a set of BEV position data features corresponding to the position data to generate a set of conditioned BEV position data features, and apply, based on the position encoding model, a second feature conditioning module to a set of perspective image data features corresponding to the image data to generate a set of conditioned perspective image data features. The processing circuitry is also configured to generate, based on the positional encoding model, the set of conditioned BEV position data features, and the set of conditioned perspective image data features, a weighted summation. The weighted summation may indicate a first relative importance of the image data for indicating characteristics of a 3D environment and a second relative importance of the position data for indicating characteristics of the 3D environment. Additionally, the processing circuitry is configured to generate, based on the weighted summation, a set of BEV image data features.

In another example, a method includes applying, based on a positional encoding model, a first feature conditioning module to a set of BEV position data features corresponding to position data to generate a set of conditioned BEV position data features, and applying, based on the position encoding model, a second feature conditioning module to a set of perspective image data features corresponding to image data to generate a set of conditioned perspective image data features. The method also includes generating, based on the positional encoding model, the set of conditioned BEV position data features, and the set of conditioned perspective image data features, a weighted summation indicating a first relative importance of the image data for indicating characteristics of a 3D environment and a second relative importance of the position data for indicating characteristics of the 3D environment. Additionally, the method includes generating, based on the weighted summation, a set of BEV image data features.

In another example, a computer-readable medium includes instructions that, when applied by processing circuitry, cause the processing circuitry to: apply, based on a positional encoding model, a first feature conditioning module to a set of BEV position data features corresponding to position data to generate a set of conditioned BEV position data features, and apply, based on the position encoding model, a second feature conditioning module to a set of perspective image data features corresponding to image data to generate a set of conditioned perspective image data features. Additionally, the instructions cause the processing circuitry to generate, based on the positional encoding model, the set of conditioned BEV position data features, and the set of conditioned perspective image data features, a weighted summation indicating a first relative importance of the image data for indicating characteristics of a 3D environment and a second relative importance of the position data for indicating characteristics of the 3D environment; and generate, based on the weighted summation, a set of BEV image data features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one to more techniques of this disclosure.

FIG. 2 is a block diagram illustrating an encoder-decoder architecture for processing image data and position data to generate an output, in accordance with one to more techniques of this disclosure.

FIG. 3 is a block diagram illustrating an example projection and fusion unit, in accordance with one or more techniques of this disclosure.

FIG. 4 is a block diagram illustrating an example feature conditioning module 400, in accordance with one or more techniques of this disclosure.

FIG. 5A is a block diagram illustrating an example self-attention block, in accordance with one or more techniques of this disclosure.

FIG. 5B is a block diagram illustrating a first example cross-attention block, in accordance with one or more techniques of this disclosure.

FIG. 5C is a block diagram illustrating a second example cross-attention block, in accordance with one or more techniques of this disclosure.

FIG. 6 is a flow diagram illustrating an example method for calculating a weighted summation based on image data features and position data features, in accordance with one or more techniques of this disclosure.

### DETAILED DESCRIPTION

Camera and Light Detection and Ranging (LiDAR) systems may be used together in various different robotic, vehicular, and virtual reality (VR). One such vehicular application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and relative speed of objects around the vehicle. LiDAR sensors provide three-dimensional (3D) data, enabling the ADAS to create a detailed map of the surrounding environment. LiDAR may be particularly effective in low-light or adverse weather conditions, where camera performance may be hindered. In some examples, the output of a LiDAR sensor may be used as partial ground truth data for performing neural network-based depth information on corresponding camera images.

By fusing the data gathered from both camera and LiDAR sensors, an ADAS or another kind of system can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

The present disclosure generally relates to techniques and devices for generating bird's eye view (BEV) features based on position data collected by a LiDAR sensor (e.g., a 3D point cloud), generating BEV features based on image data captured by a camera (e.g., a two-dimensional (2D) image), and fusing the BEV features. As described above, cameras and LiDAR sensors may be used in vehicular, robotic, and VR applications as sources of information that may be used to determine the location, pose, and potential actions of physical objects in the outside world. However, features extracted from data collected by these sensors may vary in importance for indicating characteristics of these physical objects. Since the importance of extracted features for indicating characteristics of objects in a 3D environment is useful information for generating BEV features, it may be beneficial for a system to generate BEV features based on the relative importance of image data and position data. This disclosure describes techniques for generating a set of BEV features based on image data in a way that better accounts for the relative importance of image data for indicating characteristics of one or more objects and the importance of position data for indicating characteristics of one or more objects.

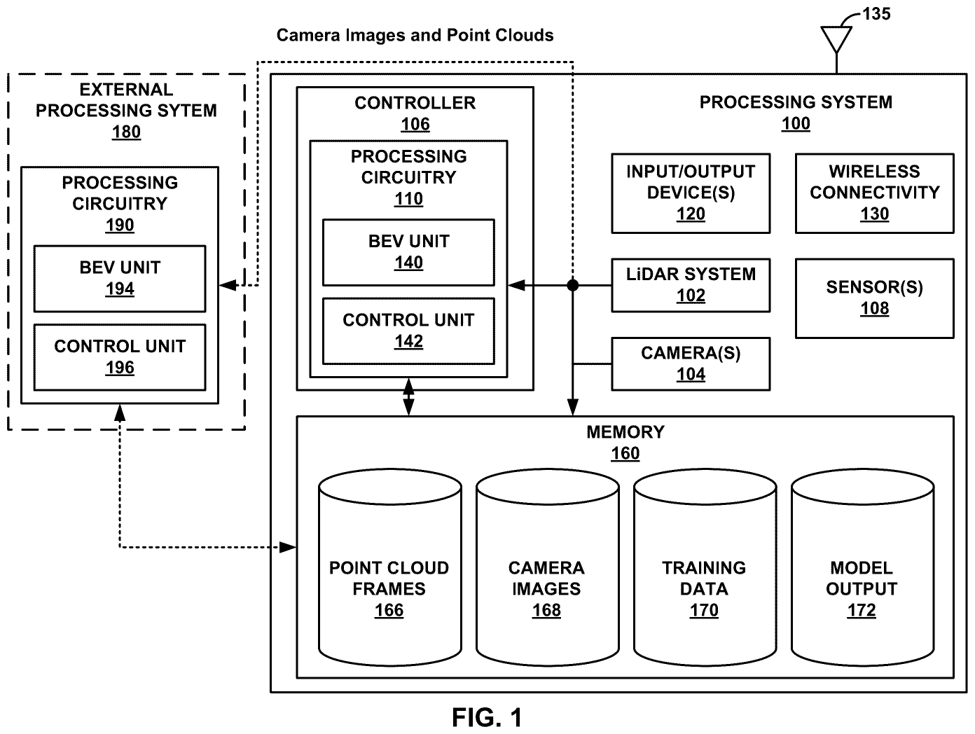

FIG. 1 is a block diagram illustrating an example processing system 100, in accordance with one to more techniques of this disclosure. Processing system 100 may be used in a vehicle, such as an autonomous driving vehicle or an assisted driving vehicle (e.g., a vehicle having an advanced driver-assistance systems (ADAS) or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes image data and/or position data.

Processing system 100 may include LiDAR system 102, camera(s) 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames mased on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera(s) 104. The color attribute includes color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may be any type of camera configured to capture video or image data in the environment around processing system 100 (e.g., around a vehicle). In some examples, processing system 100 may include multiple cameras 104. For example, camera(s) 104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 104 may be a color camera or a grayscale camera. In some examples, camera(s) 104 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

LiDAR system 102 may, in some examples, be configured to collect point cloud frames 166. Camera(s) 104 may, in some examples, be configured to collect camera images 168. An importance of data input modalities such as point cloud frames 166 and camera images 168 may vary for indicating one or more characteristics of objects in a 3D environment. For example, when color and texture are important characteristics of a first object and when color and texture are not important characteristics of a second object, camera images 168 may be more important for identifying characteristics of the first object as compared with the importance of camera images 168 for identifying characteristics of the second object. It may be beneficial to consider the importance of point cloud frames 166 and camera images 168 for indicating characteristics of a 3D environment when generating BEV features corresponding to point cloud frames 166 and/or generating BEV features corresponding to camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with LiDAR system 102, camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

Processing system 100 may be configured to perform techniques for extracting features from image data and position data, processing the features, fusing the features, or any combination thereof. For example, processing circuitry 110 may include BEV unit 140. BEV unit 140 may be implemented in software, firmware, and/or any combination of hardware described herein. As will be described in more detail below, BEV unit 140 may be configured to receive a plurality of camera images 168 captured by camera(s) 104 and receive a plurality of point cloud frames 166 captured by LiDAR system 102. BEV unit 140 may be configured to receive camera images 168 and point cloud frames 166 directly from camera(s) 104 and LiDAR system 102, respectively, or from memory 160. In some examples, the plurality of point cloud frames 166 may be referred to herein as “position data.” In some examples, the plurality of camera images 168 may be referred to herein as “image data.”

In general, BEV unit 140 may fuse features corresponding to the plurality of point cloud frames 166 and features corresponding to the plurality of camera images 168 in order to combine image data corresponding to one or more objects within a 3D space with position data corresponding to the one or more objects. For example, each camera image of the plurality of camera images 168 may comprise a 2D array of pixels that includes image data corresponding to one or more objects. Each point cloud frame of the plurality of point cloud frames 166 may include a 3D multi-dimensional array of points corresponding to the one or more objects. Since the one or more objects are located in the same 3D space where processing system 100 is located, it may be beneficial to fuse features of the image data present in camera images 168 that indicate information corresponding to the identity one or more objects with features of the position data present in the point cloud frames 166 that indicate a location of the one or more objects within the 3D space. This is because image data may include at least some information that position data does not include, and position data may include at least some information that image data does not include.

Fusing features of image data and features of position data may provide a more comprehensive view of a 3D environment corresponding to processing system 100 as compared with analyzing features of image data and features of position data separately. For example, the plurality of point cloud frames 166 may indicate an object in front of a processing system 100, and BEV unit 140 may be able to process the plurality of point cloud frames 166 to determine that the object is a stoplight. This is because the plurality of point cloud frames 166 may indicate that the object includes three round components oriented vertically and/or horizontally relative to a surface of a road intersection, and the plurality of point cloud frames 166 may indicate that the size of the object is within a range of sizes that stoplights normally occupy. But the plurality of point cloud frames 166 might not include information that indicates which of the three lights of the stoplight is turned on and which of the three lights of the stoplight is turned off. Camera images 168 may include image data indicating that a green light of the stoplight is turned on, for example. This means that it may be beneficial to fuse features of image data with features of position data so that BEV unit 140 can analyze image data and position data to determine characteristics of one or more objects within the 3D environment.

BEV unit 140 may be configured to extract features from point cloud frames 166 and/or extract features from camera images 168. For example, BEV unit 140 may apply a first encoder to extract, from camera images 168, a first set of features. In some examples, the first set of features may represent perspective view features from the perspective of camera(s) 104. Additionally, or alternatively, BEV unit 140 may apply a second encoder to extract, from point cloud frames 166, a second set of features. In some examples, the second set of features may include 3D sparse features. An encoder may include one or more nodes that map input data into a representation of the input data in order to “extract” features of the data. Features may represent information output from the encoder that indicates one or more characteristics of the data. It may be beneficial for an encoder to output features of input data that accurately represent the input data. For example, it may be beneficial for an encoder to output features that accurately identify one or more characteristics of objects within the 3D environment. It may also be beneficial for an encoder to output features of input data that indicate a large volume of characteristics of objects within the 3D environment. The greater the number of characteristics indicated by extracted features, the more useful the features may be for generating an output to perform one or more tasks.

Processing system 100 may be configured to identify one or more characteristics of a 3D environment for generating an output to perform one or more tasks. Point cloud frames 166 and camera images 168 may each indicate characteristics that are important for generating the output, but the importance of point cloud frames 166 and camera images 168 may vary in different scenarios. For example, camera images 168 may indicate both the text printed on a road sign and a shape of the road sign, whereas point cloud frames 166 may indicate the shape of the road sign without indicating the text printed on the road sign. Additionally, or alternatively, point cloud frames 166 may indicate a location of the road sign relative to processing system 100, whereas camera images 168 might not indicate a distance between the road sign and processing system 100. Consequently, it may be beneficial for processing system 100 to weigh the importance of point cloud frames 166 and the importance of camera images 168 for indicating characteristics of the 3D environment.

BEV unit 140 may be configured to use feature conditioning modules and/or positional encoding models to weigh the importance of point cloud frames 166 and the importance of camera images 168 for indicating characteristics of the 3D environment. A feature conditioning module may be configured to accept features and learned positional encoding as an input, and generate conditioned features as an output. The conditioned features may reflect the importance of the data modality corresponding to the features for indicating characteristics of the 3D environment. Positional encoding models may output learned positional encoding. The positional encoding models may be trained using a set of training data.

In some examples, BEV unit 140 is configured to apply, based on a positional encoding model, a first feature conditioning module to a set of BEV position data features corresponding to position data (e.g., point cloud frames 166) to generate a set of conditioned BEV position data features. For example, BEV unit 140 may be configured to apply an encoder to camera images 168 to generate a set of perspective image data features. Additionally, or alternatively, BEV unit 140 may be configured to apply an encoder to point cloud frames 166 to generate a set of 3D position data features. It may be beneficial for BEV unit 140 to generate a set of BEV image data features and a set of BEV position data features in order to fuse the sets of BEV features to generate an output. Weighing the importance of point cloud frames 166 and camera images 168 for indicating characteristics of the 3D environment in generating the set of BEV image data features may improve the fused set of BEV features as compared with systems that do not weigh the importance of point cloud frames 166 and camera images 168 for indicating characteristics of the 3D environment. By applying the first feature conditioning module to generate the set of conditioned BEV position data features, BEV unit 140 may determine the importance of point cloud frames 166 for indicating characteristics of the 3D environment.

BEV unit 140 may be configured to apply, based on the positional encoding model, a second feature conditioning module to a set of perspective image data features corresponding to image data (e.g., camera images 168) to generate a set of conditioned perspective image data features. For example, BEV unit 140 may be configured to apply an encoder to camera images 168 to generate a set of perspective image data features. The set of perspective image data features may indicate characteristics of the 3D environment from the perspective of camera(s) 104. BEV unit 140 may project the set of perspective view features onto a 2D BEV representation. In projecting the set of perspective view features onto a 2D BEV representation, BEV unit 140 may weigh the importance of point cloud frames 166 and camera images 168 for indicating characteristics of the 3D environment.

For example, BEV unit 140 may generate, based on the positional encoding model, the conditioned BEV position data features, and the conditioned perspective image data features, a weighted summation indicating an importance of camera images 168 for generating an output and an importance of point cloud frames 166 for generating an output. The importance of camera images 168 for generating an output may represent an importance of camera images 168 for indicating one or more characteristics of the 3D environment that are useful for generating an output to perform one or more tasks. The importance of point cloud frames 166 for generating an output may represent an importance of point cloud frames 166 for indicating one or more characteristics of the 3D environment that are useful for generating an output to perform one or more tasks.

The weighted summation may place image features more prominently than position features if image features are more informative of characteristics of the 3D environment useful for achieving one or more tasks. The weighted summation may place position data features more prominently than image data features if position features are more informative of characteristics of the 3D environment useful for achieving one or more tasks.

For example, when the one or more tasks include controlling a vehicle within the 3D environment, the weighted summation may place image data features more prominently than position data features in generating BEV features corresponding to a stoplight, because image data features may indicate the shape and the color of the stoplight, whereas the position data features indicate the shape of the stoplight and the location of the stoplight within the 3D environment without indicating the color of the stoplight. Since the color of the stoplight is important for determining whether to control the vehicle to move through an intersection or to control the vehicle to stop at the intersection, the weighted summation may place the image data features more prominently than the weighted summation places the position data features. But even though the weight of the position data features in this example might not be as high as the weight of the image data features, the weight of the position data features might not be zero because the location of the stoplight within the 3D environment is useful for determining where to cause the vehicle to stop if the stoplight is red.

In another example where processing system 100 controls a vehicle based on the output, the weighted summation may place position data features more prominently than image data features in generating BEV features corresponding to a moving pedestrian, because position data features may indicate the shape of the pedestrian, a location of the pedestrian relative to the vehicle, a direction in which the pedestrian is moving, and a speed at which the pedestrian is moving. On the other hand, the image data features might indicate a shape of the pedestrian and a color of the pedestrian's clothing, without indicating the location, direction, and speed of the pedestrian as accurately as the position data features indicate the location, direction, and speed of the pedestrian. Since the location, direction of movement, and speed of the pedestrian within the 3D environment are important for controlling the vehicle to avoid hitting the moving pedestrian, and since the color of the pedestrian's clothing is not important for controlling the vehicle, the weighted summation may place position data features corresponding to the pedestrian more prominently than the weighted summation places image data features corresponding to the pedestrian.

BEV unit 140 may generate, based on the weighted summation and based on the set of perspective image data features extracted from camera images 168, a set of BEV image data features. Since the weighted summation accounts for the relative importance of point cloud frames 166 and camera images 168 for indicating characteristics of the 3D environment, BEV unit 140 may generate the set of BEV image data features to include more important information than other techniques. BEV unit 140 is also configured to generate a set of BEV position data features based on a set of 3D position data features extracted from point cloud frames 166. BEV unit 140 may fuse the set of BEV image data features with the set of BEV position data features to create a fused set of BEV features. By generating the set of BEV image data features based on the weighted summation, BEV unit 140 may cause the fused set of BEV features to include a greater amount of useful information for generating an output as compared with systems that do not generate a set of BEV image data features based on a weighted summation indicating a relative importance of point cloud frames 166 and camera images 168 for indicating characteristics of a 3D environment.

BEV unit 140 may, in some examples, apply a positional encoding model trained with image data to the perspective image data features extracted from camera images 168 to generate a set of conditioned perspective image data features. In some examples, the positional encoding model trained with the image data is different than the positional encoding model used to generate the weighted summation. BEV unit 140 may generate the set of BEV image data features based on the weighted summation, the set of perspective image data features, and the set of conditioned perspective image data features generated by applying the positional encoding model trained with the image data.

In some examples, to generate the set of BEV image data features, the BEV unit 140 may apply a self-attention block to the set of perspective image data features and the set of conditioned perspective image data features. That is, BEV unit 140 may combine the set of perspective image data features and the set of conditioned perspective image data features and apply the self-attention block to the combined features. BEV unit 140 may apply a cross-attention block to the first projection output and the weighted summation to generate a second projection output comprising the set of BEV image data features. The self-attention block and the cross-attention block may “project” the perspective image data features onto a BEV representation such that the set of BEV image data features indicate characteristics of the 3D environment from a perspective above one or more objects within the 3D environment looking down at the one or more objects.

BEV unit 140 may fuse a set of BEV position data features and a set of BEV image data features to generate a fused set of BEV features. By generating the set of BEV position data features and the set of BEV image data features, BEV unit 140 may be configured to create the fused set of BEV features to include more important information present in point cloud frames 166 and camera images 168 for indicating characteristics of the 3D environment from a perspective looking down at one or more objects within the 3D environment. BEV unit 140 may generate an output based on the fused set of BEV features. In some examples, BEV unit 140 may apply one or more decoders to the fused set of BEV features to generate the output.

For example, BEV unit 140 may apply a first decoder to the output to generate a set of 3D bounding boxes that indicate a shape of one or more objects within a 3D environment. Additionally, or alternatively, BEV unit 140 may apply a second decoder to generate a 2D representation of the 3D environment from a perspective above the one or more objects looking down at the one or more objects. The output generated by BEV unit 140 may indicate one or more characteristics of the 3D environment corresponding to processing system 100 in a way that allows processing system 100 to control an object (e.g., a vehicle or another object) within the 3D environment.

In some examples, processing circuitry 110 may be configured to train one or more encoders, decoders, positional encoding models, or any combination thereof applied by BEV unit 140 using training data 170. For example, training data 170 may include one or more training point cloud frames and/or one or more camera images. Training data 170 may additionally or alternatively include features known to accurately represent one or more point cloud frames and/or features known to accurately represent one or more camera images. This may allow processing circuitry 110 to train an encoder to generate features that accurately represent point cloud frames and train an encoder to generate features that accurately represent camera images. Processing circuitry 110 may also use training data 170 to train one or more decoders. Processing circuitry 110 may additionally or alternatively train positional encoder models to identify patterns in image data features and position data features associated value for indicating characteristics of a 3D environment.

Processing circuitry 110 of controller 106 may apply control unit 142 to control, based on the output generated by BEV unit 140 by applying the third decoder to the fused sets of reweighed BEV features, an object (e.g., a vehicle, a robotic arm, or another object that is controllable based on the output from BEV unit 140) corresponding to processing system 100. Control unit 142 may control the object based on information included in the output generated by BEV unit 140 relating to one or more objects within a 3D space including processing system 100. For example, the output generated by BEV unit 140 may include an identity of one or more objects, a position of one or more objects relative to the processing system 100, characteristics of movement (e.g., speed, acceleration) of one or more objects, or any combination thereof. Based on this information, control unit 142 may control the object corresponding to processing system 100. The output from BEV unit 140 may be stored in memory 160 as model output 172.

The techniques of this disclosure may also be performed by external processing system 180. That is, encoding input data, transforming features into BEV features, weighing features, fusing features, and decoding features, may be performed by a processing system that does not include the various sensors shown for processing system 100. Such a process may be referred to as “offline” data processing, where the output is determined from a set of test point clouds and test images received from processing system 100. External processing system 180 may send an output to processing system 100 (e.g., an ADAS or vehicle).

External processing system 180 may include processing circuitry 190, which may be any of the types of processors described above for processing circuitry 110. Processing circuitry 190 may include a BEV unit 194 is configured to perform the same processes as BEV unit 140. Processing circuitry 190 may acquire point cloud frames 166 and camera images 168 directly from LiDAR system 102 and camera(s) 104, respectively, or from memory 160. Though not shown, external processing system 180 may also include a memory that may be configured to store point cloud frames, camera images, model outputs, among other data that may be used in data processing. BEV unit 194 may be configured to perform any of the techniques described as being performed by BEV unit 140. Control unit 196 may be configured to perform any of the techniques described as being performed by control unit 142.

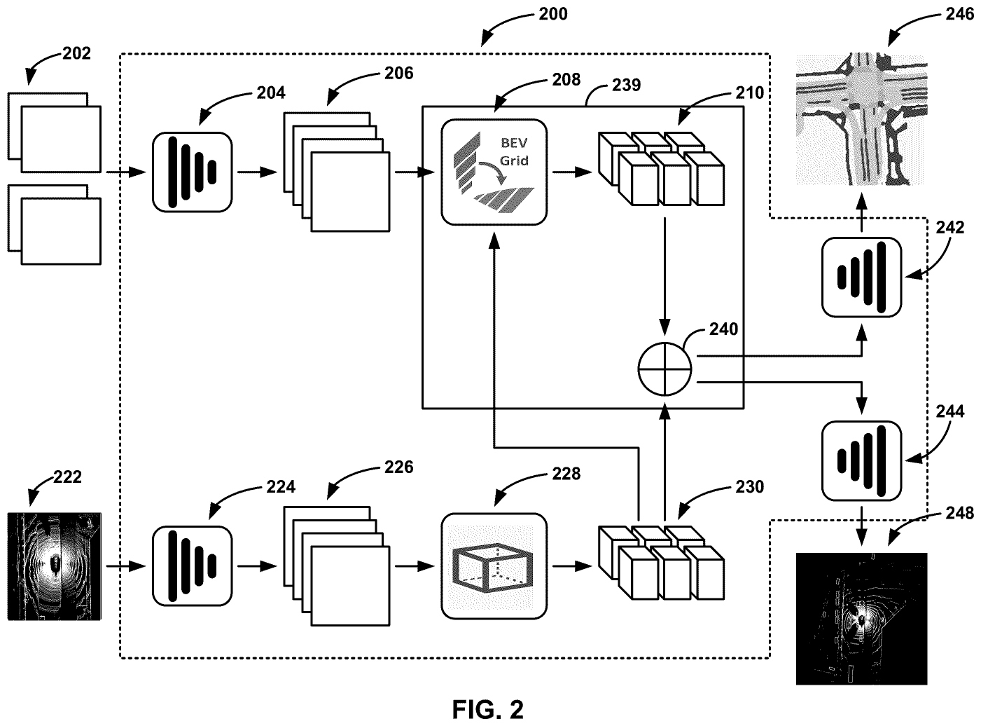

FIG. 2 is a block diagram illustrating an encoder-decoder architecture 200 for processing image data and position data to generate an output, in accordance with one to more techniques of this disclosure. In some examples, encoder-decoder architecture 200 may be a part of BEV unit 140 and/or BEV unit 194 of FIG. 1. FIG. 2 illustrates camera images 202, first encoder 204, perspective view features 206, projection unit 208, first set of BEV features 210, point cloud frames 222, second encoder 224, 3D sparse features 226, flattening unit 228, second set of BEV features 230, BEV feature fusion unit 240, first decoder 242, second decoder 244, first output 246, and second output 248.

Camera images 202 may be examples of camera images 168 of FIG. 1. In some examples, camera images 202 may represent a set of camera images from camera images 168 and camera images 168 may include one or more camera images that are not present in camera images 202. In some examples, camera images 202 may be received from a plurality of cameras at different locations and/or different fields of view, which may be overlapping. In some examples, encoder-decoder architecture 200 processes camera images 202 in real time or near real time so that as camera(s) 104 captures camera images 202, encoder-decoder architecture 200 processes the captured camera images. In some examples, camera images 202 may represent one or more perspective views of one or more objects within a 3D space where processing system 100 is located. That is, the one or more perspective views may represent views from the perspective of processing system 100.

Encoder-decoder architecture 200 includes encoders 204, 224 and decoders 242, 244. Encoder-decoder architecture 200 may be configured to process image data and position data (e.g., point cloud data). An encoder-decoder architecture for image feature extraction is commonly used in computer vision tasks, such as image captioning, image-to-image translation, and image generation. The encoder-decoder architecture may transform input data into a compact and meaningful representation known as a feature vector that captures salient visual information from the input data. The encoder may extract features from the input data, while the decoder reconstructs the input data from the learned features.

In some cases, an encoder is built using convolutional neural network (CNN) layers to analyze input data in a hierarchical manner. The CNN layers may apply filters to capture local patterns and gradually combine them to form higher-level features. Each convolutional layer extracts increasingly complex visual representations from the input data. These representations may be compressed and down sampled through operations such as pooling or strided convolutions, reducing spatial dimensions while preserving desired information. The final output of the encoder may represent a flattened feature vector that encodes the input data's high-level visual features.

A decoder may be built using transposed convolutional layers or fully connected layers, may reconstruct the input data from the learned feature representation. A decoder may take the feature vector obtained from the encoder as input and processes it to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During training, an encoder-decoder architecture for feature extraction is trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Encoders and decoders of encoder-decoder architecture 200 may be trained using training data 170.

An encoder-decoder architecture for image and/or position feature extraction may comprise one or more encoders that extract high-level features from the input data and one or more decoders that reconstruct the input data from the learned features. This architecture may allow for the transformation of input data into compact and meaningful representations. The encoder-decoder framework may enable the model to learn and utilize important visual and positional features, facilitating tasks like image generation, captioning, and translation.

First encoder 204 may represent an encoder of a neural network or another kind of model that is configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

In some examples, the first encoder 204 represents a CNN, another kind of artificial neural network (ANN), or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

First encoder 204 may generate a set of perspective view features 206 based on camera images 202. Perspective view features 206 may provide information corresponding to one or more objects depicted in camera images 202 from the perspective of camera(s) 104 which captures camera images 202. For example, perspective view features 206 may include vanishing points and vanishing lines that indicate a point at which parallel lines converge or disappear, a direction of dominant lines, a structure or orientation of objects, or any combination thereof. Perspective view features 206 may include color information. Additionally, or alternatively, perspective view features 206 may include key points that are matched across a group of two or more camera images of camera images 202. Key points may allow encoder-decoder architecture 200 to determine one or more characteristics of motion and pose of objects. Perspective view features 206 may, in some examples, include depth-based features that indicate a distance of one or more objects from the camera, but this is not required. Perspective view features 206 may include any one or combination of image features that indicate characteristics of camera images 202.

It may be beneficial for encoder-decoder architecture 200 to transform perspective view features 206 into BEV features that represent the one or more objects within the 3D environment on a grid from a perspective looking down at the one or more objects from a position above the one or more objects. Since encoder-decoder architecture 200 may be part of an ADAS for controlling a vehicle, and since vehicles move generally across the ground in a way that is observable from a bird's eye perspective, generating BEV features may allow a control unit (e.g., control unit 142 and/or control unit 196) of FIG. 1 to control the vehicle based on the representation of the one or more objects from a bird's eye perspective. Encoder-decoder architecture 200 is not limited to generating BEV features for controlling a vehicle. Encoder-decoder architecture 200 may generate BEV features for controlling another object such as a robotic arm and/or perform one or more other tasks involving image segmentation, depth detection, object detection, or any combination thereof.

Projection unit 208 may transform perspective view features 206 into a first set of BEV features 210. In some examples, projection unit 208 may generate a 2D grid and project the perspective view features 206 onto the 2D grid. For example, projection unit 208 may perform perspective transformation to place objects closer to the camera on the 2D grid and place objects further form the camera on the 2D grid. In some examples, the 2D grid may include a predetermined number of rows and a predetermined number of columns, but this is not required. Projection unit 208 may, in some examples, set the number of rows and the number of columns. In any case, projection unit 208 may generate the first set of BEV features 210 that represent information present in perspective view features 206 on a 2D grid including the one or more objects from a perspective above the one or more objects looking down at the one or more objects.

In some examples, projection unit 208 may use one or more self-attention blocks and/or cross-attention blocks to transform perspective view features 206 into the first set of BEV features 210. Cross-attention blocks may allow projection unit 208 to process different regions and/or objects of perspective view features 206 while considering relationships between the different regions and/or objects. Self-attention blocks may capture long-range dependencies within perspective view features 206. This may allow a BEV representation of the perspective view features 206 (e.g., the first set of BEV features 210) to capture relationships and dependencies between different elements, objects, and regions in the BEV representation.

Point cloud frames 222 may be examples of point cloud frames 166 of FIG. 1. In some examples, point cloud frames 222 may represent a set of camera images from point cloud frames 166 and point cloud frames 166 may include one or more point cloud frames that are not present in point cloud frames 222. In some examples, encoder-decoder architecture 200 processes point cloud frames 222 in real time or near real time so that as LiDAR system 102 generates point cloud frames 222, encoder-decoder architecture 200 processes the captured point cloud frames. In some examples, point cloud frames 222 may represent collections of point coordinates within a 3D space (e.g., x, y, z coordinates within a Cartesian space) where LiDAR system 102 is located. Since LiDAR system 102 is configured to emit light signals and receive light signals reflected off surfaces of one or more objects, the collections of point coordinates may indicate a shape and a location of surfaces of the one or more objects within the 3D space.

Second encoder 224 may represent an encoder of a neural network or another kind of model that is configured to extract information from input data and process the extracted information to generate an output. Second encoder 224 may be similar to first encoder 204 in that both the first encoder 204 and the second encoder 224 are configured to process input data to generate output features. But in some examples, first encoder 204 is configured to process 2D input data and second encoder 224 is configured to process 3D input data. In some examples, processing system 100 is configured to train first encoder 204 using a set of training data of training data 170 that includes one or more training camera images and processing system 100 is configured to train second encoder 224 using a set of training data of training data 170 that includes one or more point cloud frames. That is, processing system 100 may train first encoder 204 to recognize one or more patterns in camera images that correspond to certain camera image perspective view features and processing system 100 may train second encoder 224 to recognize one or more patterns in point cloud frames that correspond to certain 3D sparse features.

Second encoder 224 may generate a set of 3D sparse features 226 based on point cloud frames 222. 3D sparse features 226 may provide information corresponding to one or more objects indicated by point cloud frames 222 within a 3D space that includes LiDAR system 102 which captures point cloud frames 222. 3D sparse features 226 may include key points within point cloud frames 222 that indicate unique characteristics of the one or more objects. For example, key points may include corners, straight edges, curved edges, peaks of curved edges. Encoder-decoder architecture 200 may recognize one or more objects based on key points. 3D sparse features 226 may additionally or alternatively include descriptors that allow second encoder 224 to compare and track key points across groups of two or more point cloud frames of point cloud frames 222. Other kids of 3D sparse features 226 include voxels and super pixels.

Flattening unit 228 may transform 3D sparse features 226 into a second set of BEV features 230. In some examples, flattening unit 228 may define a 2D grid of cells and project the 3D sparse features onto the 2D grid of cells. For example, flattening unit 228 may project 3D coordinates of 3D sparse features (e.g., cartesian coordinates key points, voxels) onto a corresponding 2D coordinate of the 2D grid of cells. Flattening unit 228 may aggregate one or more sparse features within each cell of the 2D grid of cells. For example, flattening unit 228 may count a number of features within a cell, average attributes of features within a cell, or take a minimum or maximum value of a feature within a cell. Flattening unit 228 may normalize the features within each cell of the 2D grid of cells, but this is not required. Flattening unit 228 may flatten the features within each cell of the 2D grid of cells into a 2D array representation that captures characteristics of the 3D sparse features projected into each cell of the 2D grid of cells.

Since point cloud frames 222 represent multi-dimensional arrays of cartesian coordinates, flattening unit 228 may generate the second set of BEV features 230 by compressing one of the dimensions of the x, y, z cartesian space into a flattened plane without compressing the other two dimensions. That is, the points within a column of points parallel to one of the dimensions of the x, y, z cartesian space may be compressed into a single point on a 2D space formed by the two dimensions that are not compressed. Perspective view features 206 extracted from camera images 202, on the other hand, might not include cartesian coordinates. This means that it may be beneficial for projection unit 208 to receive the second set of BEV features 230 to aid in projecting perspective view features 206 onto a 2D BEV space to generate the first set of BEV features 210.

Projection unit 208 may generate the first set of BEV features 210 in a way that weighs an importance of image data for indicating characteristics of the 3D environment corresponding to processing system 100 and an importance of position data for indicating characteristics of the 3D environment corresponding to processing system 100. Image data may include information corresponding to one or more objects within the 3D environment that is not present in position data, and position data may include one information corresponding to one or more objects within the 3D environment that is not present in image data.

In some cases, information present in image data that is not present in position data is more important for generating an output to perform one or more tasks, and in other cases, information present in image data that is not present in position data is less important for generating an output to perform one or more tasks. In some cases, information present in position data that is not present in image data is more important for generating an output to perform one or more tasks, and in other cases, information present in position data that is not present in image data is less important for generating an output to perform one or more tasks. This means that it may be beneficial for projection unit 208 to generate the first set of BEV features 210 to account for the relevant importance of image data and position data for indicating characteristics of the 3D environment that are useful for generating an output.

To account for the relative importance of image data and position data for identifying characteristics of the 3D environment that are useful for generating an output to perform one or more tasks, projection unit 208 may condition perspective view features 206 extracted from camera images 202 and condition the second set of BEV features 230 generated from the 3D sparse features 226 extracted from point cloud frames 222 to determine a weighted summation. This weighted summation may indicate the relative importance of camera images 202 and the relative importance of point cloud frames 222 for generating an output to perform one or more tasks. Projection unit 208 may use the weighted summation to generate the first set of BEV features 210 to account for the relative importance of camera images 202 and the relative importance of point cloud frames 222 for generating an output to perform one or more tasks.

In some examples, point cloud frames 222 may include more precise position information indicating a location of one or more objects within the 3D environment, and camera images 202 may include less precise information concerning the position of one or more objects. For example, point cloud frames 222 may indicate a precise location, in Cartesian coordinates, of two objects. The Cartesian coordinates may indicate a precise distance of each of the two objects from LiDAR system 102. Camera images 202 may depict visual characteristics of each of the two objects including color, texture, and shape information, but might not include information concerning the precise distance of each of the two objects from camera(s) 104. Camera images 202 may indicate that one of the objects is between the other object and camera(s) 104, but might not indicate precise distances.

Projection unit 208 may condition perspective view features 206 and condition the second set of BEV features 230 to determine the weighted summation so that the first set of BEV features 210 indicates more useful information corresponding to each object of one or more objects within the 3D environment as compared with BEV features generated using other techniques. For example, when the precise location of a pedestrian is important for generating an output to control a vehicle, the weighted summation may weight position data features more heavily than the weighted summation weights image data features for indicating characteristics of the pedestrian in the first set of BEV features 210. When the text on a traffic sign and/or the color of a stoplight is important for generating an output to control a vehicle, the weighted summation may weight image data features more heavily than the weighted summation weights position data features for indicating characteristics of the traffic sign and/or the stoplight for indicating characteristics of the traffic sign and/or the stoplight in the first set of BEV features 210. That is, the weighted summation may weight the relative importance of image data and position data for indicating the characteristic of each object and/or each region of one or more objects and regions in the 3D environment. This may ensure that the set of BEV features 210 include more relevant information concerning the 3D environment for generating an output to perform one or more tasks as compared with BEV features generated using other techniques.

To condition perspective view features 206 and condition the second set of BEV features 230, projection unit 208 may use one or more positional encoding models trained using training data (e.g., training data 170 of FIG. 1). For example, projection unit 208 may use a first positional encoding model to condition perspective view features 206 and use the first positional encoding model to condition the second set of BEV features 230. Based on the conditioned perspective view features 206, the conditioned second set of BEV features 230, and the first positional encoding model, projection unit 208 may determine the weighted summation. Additionally, or alternatively, projection unit 208 may use a second feature conditioning module to condition the perspective view features 206. Based on the weighted summation, perspective view features 206, and/or the conditioned perspective view features 206 conditioned using the second positional encoding model, projection unit 208 may generate the first set of BEV features 210.

In some examples, a projection and fusion unit 239 may include projection unit 208 and BEV feature fusion unit 240. BEV feature fusion unit 240 may be configured to fuse the first set of BEV features 210 and the second set of BEV features 230 to generate a fused set of BEV features. In some examples, BEV feature fusion unit 240 may use a concatenation operation to fuse the first set of BEV features 210 and the second set of BEV features 230. The concatenation operation may combine the first set of BEV features 210 and the second set of BEV features 230 so that the fused set of BEV features includes useful information present in each of the first set of BEV features 210 and the second set of BEV features 230. By using projection unit 208 to generate the first set of BEV features 210 to indicate the relative importance of each of position data and image data for indicating characteristics of the 3D environment, BEV feature fusion unit 240 may be configured to fuse the first set of BEV features 210 and the second set of BEV features 230 in a way that indicates a greater amount of useful information for generating an output as compared with systems that do not generate BEV features for image data to account for the relative importance of image data and position data.

Encoder-decoder architecture 200 may include first decoder 242 and second decoder 244. In some examples, each of first decoder 242 and second decoder 244 may represent a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more spatial dimensions of the features, increase a complexity of the features, or increase a resolution of the features. A final layer of a decoder may generate a reconstructed output that includes an expanded representation of the features extracted by an encoder.

First decoder 242 may be configured to generate a first output 246 based on the fused set of BEV features. The first output 246 may comprise a 2D BEV representation of the 3D environment corresponding to processing system 100. For example, when processing system 100 is part of an ADAS for controlling a vehicle, the first output 246 may indicate a BEV view of one or more roads, road signs, road markers, traffic lights, vehicles, pedestrians, and other objects within the 3D environment corresponding to processing system 100. This may allow processing system 100 to use the first output 246 to control the vehicle within the 3D environment.

Since the output from first decoder 242 includes a bird's eye view of one or more objects that are in a 3D environment corresponding to encoder-decoder architecture 200, a control unit (e.g., control unit 142 and/or control unit 196 of FIG. 1) may use the output from first decoder 242 to control an object (e.g., a vehicle, one or more robotic components) within the 3D environment. For example, when the output from first decoder 242 indicates a vehicle ahead of a vehicle corresponding to processing system 100, the control unit may control the vehicle to change lanes to pass the other vehicle. In another example, when the output from first decoder 242 indicates a stop sign ahead, the control unit may control the vehicle to stop at an intersection.

Second decoder 244 may be configured to generate a second output 248 based on the fused set of BEV features. In some examples, the second output 248 may include a set of 3D bounding boxes that indicate a shape and a position of one or more objects within a 3D environment. In some examples, it may be important to generate 3D bounding boxes to determine an identity of one or more objects and/or a location of one or more objects. When processing system 100 is part of an ADAS for controlling a vehicle, processing system 100 may use the second output 248 to control the vehicle within the 3D environment. A control unit (e.g., control unit 142 and/or control unit 196 of FIG. 1) may process the second output 248 to perform one or more actions.

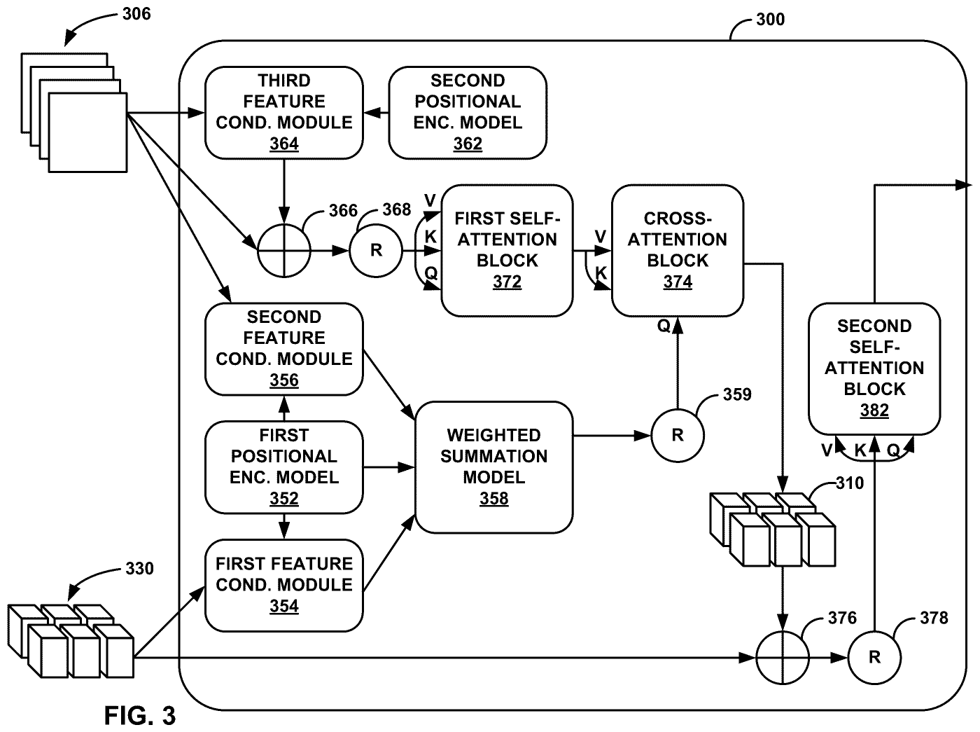

FIG. 3 is a block diagram illustrating an example projection and fusion unit 300, in accordance with one or more techniques of this disclosure. As seen in FIG. 3, projection and fusion unit 300 may be configured to receive perspective image data features 306 extracted from image data and a set of BEV position data features 330 generated based on 3D sparse features extracted from position data to create a set of BEV image data features 310. In some examples, projection and fusion unit 300 may be an example of projection and fusion unit 239 of FIG. 2. In some examples, perspective image data features 306 may be an example of perspective view features 206 of FIG. 2. In some examples, the set of BEV image data features 310 may be an example of the first set of BEV features 210 of FIG. 2. In some examples, the set of BEV position data features 330 may be an example of the second set of BEV features 230 of FIG. 2.

As seen in FIG. 3, projection and fusion unit 300 includes first positional encoding model 352, first feature conditioning module 354, second feature conditioning module 356, first weighted summation model 358, and first reshape operation unit 359. Projection and fusion unit 300 also includes second positional encoding model 362, third feature conditioning module 364, first concatenation operation unit 366, and second reshape operation unit 368. Projection and fusion unit 300 includes first self-attention block 372, cross-attention block 374, second concatenation operation unit 376, third reshape operation unit 378, and second self-attention block 382. In some examples, BEV feature fusion unit 240 of FIG. 2 includes second concatenation operation unit 376, third reshape operation unit 378, and second self-attention block 382.

Projection and fusion unit 300 may receive perspective image data features 306 and the set of BEV position data features 330. In some examples, perspective image data features may be referred to as a “set of perspective image data features.” In some examples, perspective image data features 306 may include information from image data from the perspective of camera(s) 104. In some examples, BEV position data features 330 may include information from image data from a bird's eye perspective above one or more objects in a 3D environment looking down at the one or more objects. Projection and fusion unit 300 may be configured to create, based on the perspective image data features 306 and the set of BEV position data features 330, the set of BEV image data features 310 in a way that accounts for a relative importance of image data and the relative importance of position data for indicating characteristics of a 3D environment that are useful for generating an output to perform one or more tasks. By accounting for the relative importance of image data and the relative importance of position data for indicating characteristics of a 3D environment that are useful for generating an output, projection and fusion unit 300 may improve an output generated based on the set of BEV image data features 310 and the set of BEV position data features 330 as compared with systems that do not account for the importance of position data and image data for identifying characteristics of the 3D environment.

First positional encoding model 352 may be trained using a set of training data. The set of training data may include a set of image training data comprising a set of training camera frames and a set of position training data comprising a set of training point clouds. The first positional encoding model 352 may include a set of positional encoding vectors that identify relationships between objects and/or regions in the training data. This means that the first positional encoding model 352 may indicate characteristics identified in the training data that were important for generating an output to perform one or more tasks. In some examples, first positional encoding model 352 may be trained to identify patterns for performing a particular task (e.g., controlling a vehicle), but this is not required.

Projection and fusion unit 300 may apply first feature conditioning module 354 based on first positional encoding model 352 to a set of BEV position data features 330 corresponding to position data to generate a set of conditioned BEV position data features. The set of conditioned BEV position data features may indicate a relative importance of position data for indicating one or more characteristics of the 3D environment for generating an output to perform one or more tasks. That is, when the set of BEV position data features 330 indicate many characteristics that are relevant for identifying relationships between objects within a 3D environment as recognized by first positional encoding model 352, the set of conditioned BEV position data features may indicate that position data is useful for indicating characteristics of the 3D environment. When the set of BEV position data features 330 indicate few characteristics that are relevant for identifying relationships between objects within a 3D environment as recognized by first positional encoding model 352, the set of conditioned BEV position data features may indicate that position data is less important for indicating characteristics of the 3D environment.

Projection and fusion unit 300 may apply a second feature conditioning module 356 based on the first positional encoding model 352 to a set of perspective image data features 306 corresponding to image data to generate a first set of conditioned perspective image data features. The first set of conditioned perspective image data features may indicate a relative importance of image data for indicating one or more characteristics of the 3D environment for generating an output to perform one or more tasks. That is, when the set of perspective image data features 306 indicate many characteristics that are relevant for identifying relationships between objects within a 3D environment as recognized by first positional encoding model 352, the first set of conditioned perspective image data features may indicate that image data is useful for indicating characteristics of the 3D environment. When the set of perspective image data features 306 indicate few characteristics that are relevant for identifying relationships between objects within a 3D environment as recognized by first positional encoding model 352, the first set of conditioned perspective image data features may indicate that image data is less important for indicating characteristics of the 3D environment.

Weighted summation model 358 may generate, based on first positional encoding model 352, first feature conditioning module 354, and second feature conditioning module 356, a weighted summation indicating an importance of the image data for generating an output and an importance of the position data for generating an output based on the set of BEV position data features 330 and the set of BEV image data features 310. That is, weighted summation model 358 may generate the weighted summation for generating the set of BEV image data features 310 so that when the set of BEV image data features 310 and the set of BEV position data features 330 are fused, the resulting fused set of BEV features includes a greater amount of relevant information for generating an output as compared with systems that do not generate a weighted summation.

In some examples, weighted summation model 358 may represent a machine learning model that is trained during an operation of projection and fusion unit 300. For example, weighted summation model 358 may receive information indicating an actual importance of image data and position data for identifying characteristics and compare the actual importance with an importance indicated by a weighted summation generated by weighted summation model 358. This means that weighted summation model 358 is configured to learn, during an operation of projection and fusion unit 300, one or more patterns indicative of relative importance of position data and image data. Projection and fusion unit 300 may use a first reshape operation unit 359 to process an output from weighted summation model 358. For example, the weighted summation output from weighted summation model 358 may comprise a vector and/or an array. First reshape operation unit 359 may change a shape of the vector and/or the array while ensuring that the relationship between elements of the vector and/or the array are preserved.

Second positional encoding model 362 may be trained using a set of training data. The set of training data may include a set of image training data comprising a set of training camera frames. In some examples, second positional encoding model 362 may include positional encoding for image data without including positional encoding for position data. The second positional encoding model 362 may include a set of positional encoding vectors that identify relationships between objects and/or regions in the training data. This means that the second positional encoding model 362 may indicate characteristics identified in the training data that were important for generating an output to perform one or more tasks. In some examples, second positional encoding model 362 may be trained to identify patterns for performing a particular task (e.g., controlling a vehicle), but this is not required.

Projection and fusion unit 300 may apply third feature conditioning module 364 based on second positional encoding model 362 the set of perspective image data features 306 to generate a second set of conditioned perspective image data features. Since first positional encoding model 352 is trained using both image data and position data and since second positional encoding model 362 is trained using image data without being trained using position data, the second set of conditioned perspective image data features may indicate relationships between objects indicated in image data without considering position data and the first set of conditioned perspective image data features may indicate relationships between objects indicated in image data considering both position data and image data. Projection and fusion unit 300 may use first concatenation operation unit 366 to combine the set of perspective image data features 306 and the second set of conditioned perspective image data features. Projection and fusion unit 300 may use second reshape operation unit 368 to reshape the combined set of perspective image data features 306 and second set of conditioned perspective image data features.

Attention blocks, such as self-attention blocks and cross-attention blocks, may be part of transformer-based architectures. Attention blocks may capture and model dependencies between different elements within input data, allowing the model to identify relevant information and make predictions. Self-attention blocks may weigh an importance of different elements in input data, capturing long-range dependencies effectively. Input data may first be transformed into a set of embeddings, where each element in the input is represented by a vector. These embeddings may capture semantic information of input elements.

Self-attention blocks may linearly project embeddings into three spaces: query, key, and value. For example, self-attention blocks may apply learned linear transformations to the input embeddings. The query vectors may capture elements that are being attended to. Key vectors may represent elements to which the query vectors are compared. The value vectors may hold the information that may be used to form the output. In some examples, self-attention blocks may derive query vectors, key vectors, and value vectors from the same set of input elements. In some examples, self-attention blocks may compute one or more attention weights based on query vectors and key vectors. For example, a self-attention block may compute an attention weight by computing a dot product of query vectors and key vectors. A dot product may, in some examples, capture a similarity or relevance between different input elements. A self-attention block may, in some examples, compute a weighted sum of vale vectors. Each value vector may be multiplied by its corresponding attention weight, and the weighted values may be summed together. This ensures that the self-attention block focuses on more relevant elements. A self-attention block may process a weighted sum of the value vectors by passing the weighted sum of the value vectors through a feed forward neural network. The feed forward network may include one or more linear layers and one or more non-linear activation functions. This transformation may capture complex interactions and dependencies between elements of input data.

Self-attention blocks may process a single set of input elements, whereas cross-attention blocks may process two different sets of input elements. Self-attention blocks may compute the relevance or similarity between positions within the same set of input elements. Each position within the input data may be compared with other positions within the input data to determine attention weights (e.g., determine important elements within the input data). Cross-attention blocks may accept a set of input source elements and a set of input target elements. This means that cross-attention blocks may determine more relevant elements of the set of input source elements at least in part based on the set of input target elements. Cross-attention blocks may thus align source and target information.

First self-attention block 372 may receive a set of input elements from second reshape operation unit 368. The set of input elements may include a combined set of perspective image data features 306 and the second set of conditioned perspective image data features that are reshaped by second reshape operation unit 368. As seen in FIG. 3, the value vector, key vector, and query vector input to first self-attention block 372 may be derived from the same set of input elements. The set of input elements input to first self-attention block 372 may correspond to perspective image data features 306, which are extracted from image data (e.g., camera images 202 of FIG. 2). First self-attention block 372 may process the set of input elements to identify one or more relationships between the input elements and identify more relevant elements of the set of input elements with respect to other elements of the set of input elements. First self-attention block 372 may generate an output for sending to cross-attention block 374.

Cross-attention block 374 may receive two different sets of input elements. For example, cross-attention block 374 may receive a first set of input elements corresponding to the output from first self-attention block 372 and receive a second set of input elements corresponding to the weighted summation output from weighted summation model 358. This means that cross-attention block 374 may process the output from first self-attention block 372 to identify the relevance of elements output from self-attention block based on the weighted summation output from weighted summation model 358. Since weighted summation model 358 determines the weighted summation based on both perspective image data features 306 and the set of BEV position data features 330, cross-attention block 374 may determine the relevance of elements of input data based on both image data and position data.

For example, since weighted summation model 358 may generate a weighted summation indicating an importance of the image data for generating an output and an importance of the position data for generating an output, cross-attention block 374 may assess the relevance of input elements derived from perspective image data features 306 at least in part based on the relative importance of image data and position data. As seen in FIG. 3, cross-attention block 374 may receive the first set of input elements from first self-attention block 372 as value and key inputs and cross-attention block 374 may receive the second set of input elements from first reshape operation unit 359 as a query input.

Cross-attention block 374 may generate an output comprising the set of BEV image data features 310. This means that projection and fusion unit 300 may generate the set of BEV image data features 310 based on perspective image data features 306 using first self-attention block 372 and cross-attention block 374. In some examples, the set of BEV image data features 310 may include the same dimensions as the set of BEV position data features 330 so that the set of BEV image data features 310 and the set of BEV position data features 330 can be fused. Projection and fusion unit 300 may project the perspective image data features 306 representing a perspective from camera(s) 104 onto a 2D BEV representation of the 3D environment corresponding to processing system 100.

Projection and fusion unit 300 may use second concatenation operation unit 376 to combine the set of BEV image data features 310 and the set of BEV position data features 330. Projection and fusion unit 300 may use third reshape operation unit 378 to reshape the combined set of BEV image data features 310 and the set of BEV position data features 330 for input to second self-attention block 382. Second self-attention block 382 may process the output from third reshape operation unit 378 to generate a fused set of BEV features.

Projection and fusion unit 300 may represent a multi-modal feature fusion and BEV Projection unit for generating an output to perform one or more downstream tasks such as image segmentation, depth detection, 3D object detection, or any combination thereof. Projection and fusion unit 300 may process each data modality (e.g., image data and position data) may be first processed with a modality specific network to produce feature maps (e.g., a multi-camera feature map and a LIDAR BEV feature map). The feature maps may be passed to projection and fusion unit 300 (e.g., multi-modal feature fusion and BEV projection unit).

Processing system 100 may create an image learned positional encoding (e.g., second positional encoding model 362). The learned image positional encoding may be guided by image feature maps using a feature conditioning module. This may create a data-dependent image positional encoding. In some examples, a condition may be deactivated, which then passes the learned positional encoding with no change. The image feature may be added to conditioned image feature maps. The output from the feature conditioning module may be reshaped and passed to n blocks of self multi-head attention (e.g., at first self-attention block 372). The output of first self-attention block 372 may be passed to m consecutive cross multi-head attention blocks (e.g., at cross-attention block 374), where image features are passed as a key, and values and the queries represent BEV queries. In some examples, projection and fusion unit 300 generates BEV queries by generating a learned BEV position encoding (e.g., first positional encoding model 352). A copy of the BEV positional encoding may be used to condition both image features (e.g., perspective image data features 306) and position features (e.g., the set of BEV position data features 330). The conditioned features may be summed, by weighted summation model 358, with adjustable and/or learnable weights. The output from the weighted summation model 358 is a query for cross-attention block 374. The output of cross-attention block 374 and the set of BEV position data features 330 may be fused via another self multi-head attention unit (e.g., second self-attention block 382).

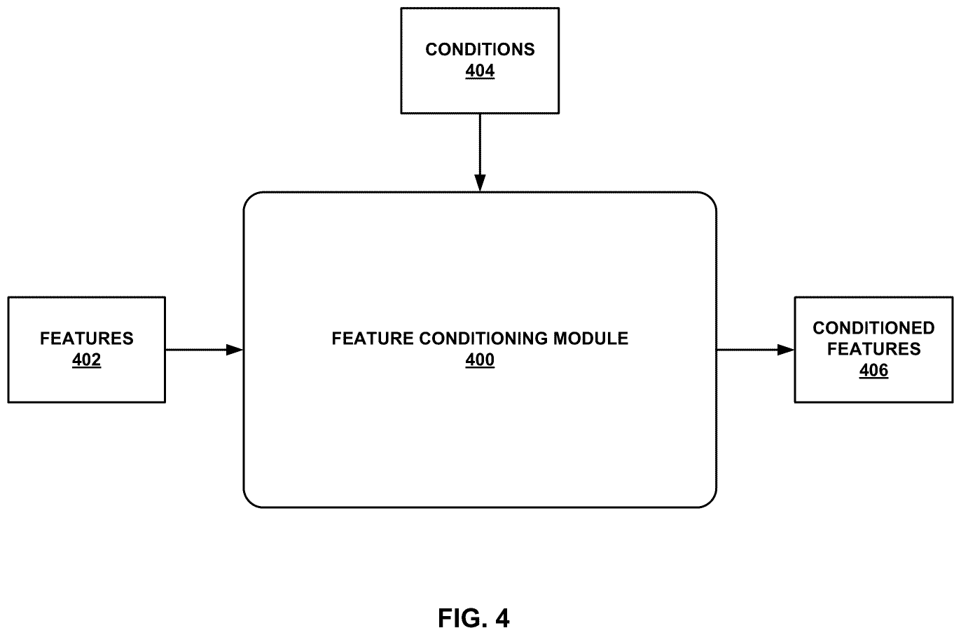

FIG. 4 is a block diagram illustrating an example feature conditioning module 400, in accordance with one or more techniques of this disclosure. Feature conditioning module 400 may be an example of any of first feature conditioning module 354 of FIG. 3, second feature conditioning module 356 of FIG. 3, and third feature conditioning module 364 of FIG. 3. As seen in FIG. 4, feature conditioning module 400 may receive features 402 and conditions 404 as inputs, and output conditioned features 406. In some examples, features 402 may include positional encoding from a positional encoding model, and conditions 404 may include a set of features extracted from input data. Feature conditioning module 400 may generate conditioned features 406 to modify conditions 404 based on information present in features 402.

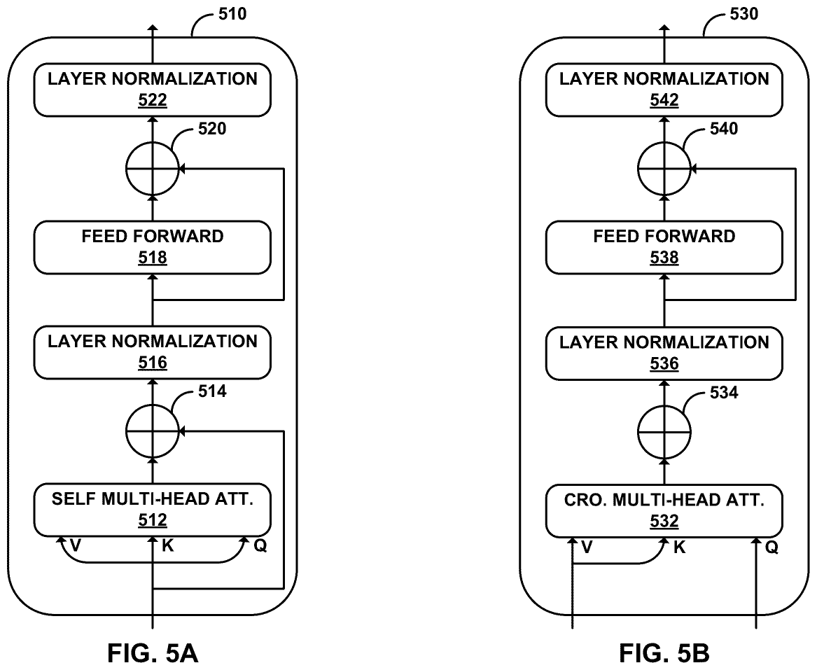

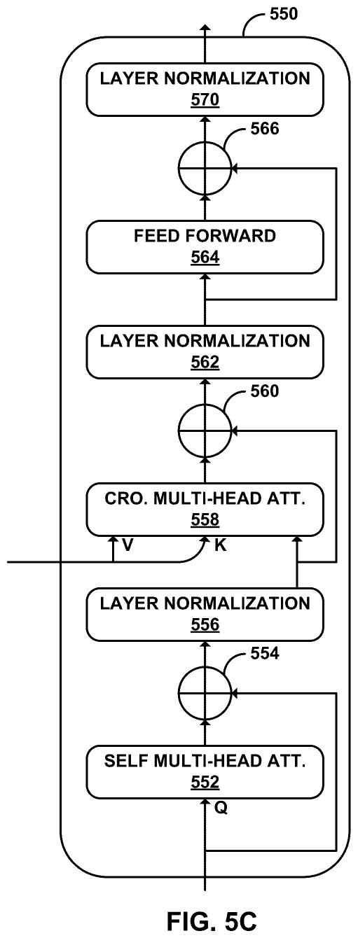

FIG. 5A is a block diagram illustrating an example self-attention block 510, in accordance with one or more techniques of this disclosure. As seen in FIG. 5A, self-attention block 510 may include a self multi-head attention unit 512, a first concatenation unit 514, a first layer normalization unit 516, a feed forward network 518, a second concatenation unit 520, and a second layer normalization unit 522. In some examples, self-attention block 510 may be an example of one or both of first self-attention block 372 and second self-attention block 382 of FIG. 3.

Self multi-head attention unit 512 may represent a component of a transformer architecture that enhances an ability of the self-attention block 510 to capture complex dependencies and relationships within input data. Self multi-head attention unit 512 may allow self-attention block 510 to attend to different positions within the same input data. Self multi-head attention unit 512 may split input data into multiple smaller subspaces, sometimes referred to as “heads,” and performs self-attention computations on each of these subspaces. Each head may be associated with a set of query, key, and value projections. The output from each of the heads may be concatenated and linearly transformed to generate an output of the self multi-head attention unit 512.

Using a set of attention heads may allow self-attention block 510 to capture different types of relationships and dependencies at different levels of granularity. By attending to different parts of the input data simultaneously, self-attention block 510 may focus on different aspects of the data and capture both local and global dependencies more effectively as compared with systems that do not use attention heads. Self multi-head attention unit 512 may receive value, key, and query values as part of the same input. First concatenation unit 514 may use a concatenation operation to combine the output from self multi-head attention unit 512 with an input to self-attention block 510.

First layer normalization unit 516 may receive a combination of the output from self multi-head attention unit 512 with the input to self-attention block 510. First layer normalization unit 516 may, in some examples, be configured to normalize values along a feature dimension for each position in the input elements to self-attention block 510. This means that the output from first layer normalization unit 516 may be scaled and shifted by learnable parameters that allow the model to adaptively rescale and shift normalized values. The layer normalization process may ensure that values of each position in the input data have a consistent distribution and are less sensitive to variations across different positions. The layer normalization process may help to mitigate an impact of covariate shift and may improve gradient flow during training. By normalizing outputs, layer normalization may reduce the internal covariate shift and improve stability and generalization capabilities of the self-attention block 510 as compared with systems that do not implement layer normalization.

Feed forward network 518 may represent a component of self-attention block 510 that receives an input from a self-attention mechanism. For example, feed forward network 518 may receive the output from first layer normalization unit 516 generated based on the output from self multi-head attention unit 512. Feed forward network 518 may process the output of an attention mechanism and apply non-linear transformations, allowing self-attention block 510 to capture complex relationships and generate expressive representations. Second concatenation unit 520 may use a concatenation operation to combine the output from feed forward network 518 with the output from first layer normalization unit 516. First layer normalization unit 516 may process the output from second concatenation unit 520 to generate the output from self-attention block 510.

FIG. 5B is a block diagram illustrating a first example cross-attention block 530, in accordance with one or more techniques of this disclosure. As seen in FIG. 5B, cross-attention block 530 may include a cross multi-head attention unit 532, a first concatenation unit 534, a first layer normalization unit 536, a feed forward network 538, a second concatenation unit 540, and a second layer normalization unit 542. In some examples, cross-attention block 530 may be an example of cross-attention block 374 of FIG. 3.

Cross multi-head attention unit 532 may handle an interaction between input sequences. Cross multi-head attention unit 532 may allow the self-attention block 510 to attend to relevant information one input string based on another input string. In some examples, cross multi-head attention unit 532 operates similarly to a self multi-head attention unit but involves attending to more than one input. For example, cross multi-head attention unit 532 may receive a first input corresponding to value and key values and receive a second input corresponding to query values. First concatenation unit 534 may process an output from cross multi-head attention unit 532 and output to first layer normalization unit 536.

First layer normalization unit 536 may normalize the output from first concatenation unit 534 and generate an output for sending to feed forward network 538. Feed forward network 538 may process the output from first layer normalization unit 536 and generate an output for sending to second concatenation unit 540. Second concatenation unit 540 may use a concatenation operation to combine the output from feed forward network 538 with the output from first layer normalization unit 536 and generate an output for sending to second layer normalization unit 542. Second layer normalization unit may generate an output from cross-attention block 530.

FIG. 5C is a block diagram illustrating a second example cross-attention block 550, in accordance with one or more techniques of this disclosure. As seen in FIG. 5C, cross-attention block 550 may include a self multi-head attention unit 552, a first concatenation unit 554, a first layer normalization unit 556, a cross multi-head attention unit 558, a second concatenation unit 560, a second layer normalization unit 562, a feed forward network 564, a third concatenation unit 566, and a third layer normalization unit 570. In some examples, cross-attention block 550 may be an example of cross-attention block 374 of FIG. 3.

Self multi-head attention unit 552 may receive a first input comprising one or more query values. Self multi-head attention unit 552 may generate an output based on the first input for sending to first concatenation unit 554. First concatenation unit 554 may combine the output from self multi-head attention unit 552 with the first input to generate an output for sending to first layer normalization unit 556. First layer normalization unit 556 may generate an output for sending to cross multi-head attention unit 558 and second concatenation unit 560.

Cross multi-head attention unit 558 may receive a second input and an output from first layer normalization unit 556. In some examples, the second input comprises value and key inputs. Cross multi-head attention unit 558 may generate an output for sending to second concatenation unit 560. Second concatenation unit 560 may use a concatenation operation to combine the output from cross multi-head attention unit 558 and the output from first layer normalization unit 556 to generate an output for sending to second layer normalization unit 562. Second layer normalization unit 562 may generate an output for sending to feed forward network 564 and third concatenation unit 566. Feed forward network 564 may generate an output for sending to third concatenation unit 566. Third concatenation unit 566 may combine the output from feed forward network 564 and the output from second layer normalization unit 562 to generate an output for sending to third layer normalization unit 570. Third layer normalization unit 570 may generate an output from cross-attention block 550.

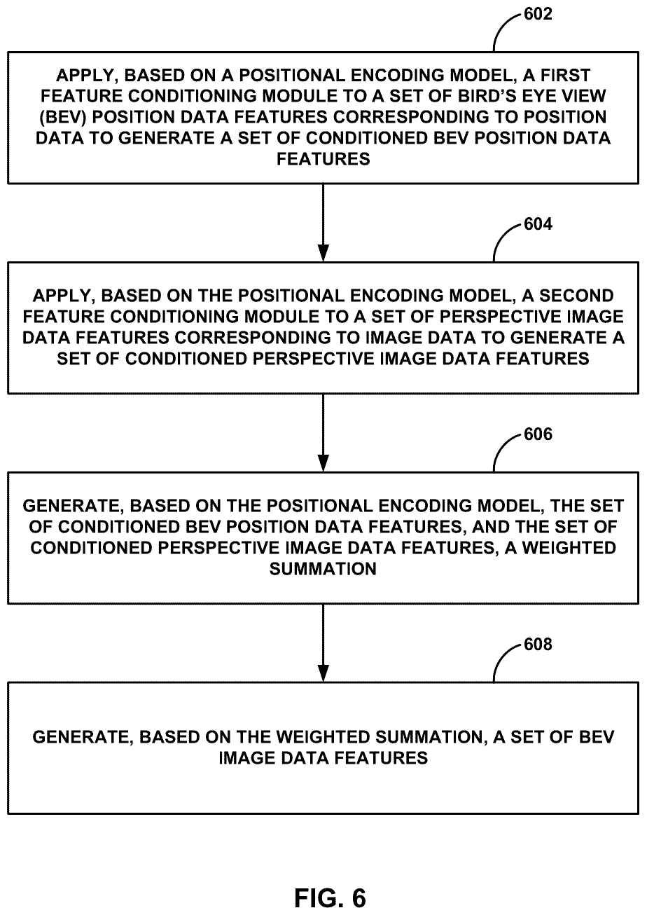

FIG. 6 is a flow diagram illustrating an example method for calculating a weighted summation based on image data features and position data features, in accordance with one or more techniques of this disclosure. FIG. 6 is described with respect to processing system 100 and external processing system 180 of FIG. 1, encoder-decoder architecture 200 of FIG. 2, and projection and fusion unit 300 of FIG. 3. However, the techniques of FIG. 6 may be performed by different components of processing system 100, external processing system 180, encoder-decoder architecture 200, projection and fusion unit 300, or by additional or alternative systems.

Projection and fusion unit 300 may apply, based on first positional encoding model 352, first feature conditioning module 354 to a set of BEV position data features 330 corresponding to position data to generate a set of conditioned BEV position data features (602). Projection and fusion unit 300 may apply, based on the first positional encoding model 352, second feature conditioning module 356 to a set of perspective image data features 306 corresponding to image data to generate a set of conditioned perspective image data features (604).

Projection and fusion unit 300 may generate, based on first positional encoding model 352, the conditioned BEV position data features, and the conditioned perspective image data features, a weighted summation (606). The weighted summation may indicate a first relative importance of the image data for indicating characteristics of a 3D environment and a second relative importance of the position data for indicating characteristics of the 3D environment. Projection and fusion unit 300 may generate, based on the weighted summation, the set of BEV image data features 310 (608).

Additional aspects of the disclosure are detailed in numbered clauses below.
Clause 1—An apparatus for processing image data and position data includes a memory for storing the image data and the position data; and processing circuitry in communication with the memory. The processing circuitry is configured to apply, based on a positional encoding model, a first feature conditioning module to a set of BEV position data features corresponding to the position data to generate a set of conditioned BEV position data features, and apply, based on the position encoding model, a second feature conditioning module to a set of perspective image data features corresponding to the image data to generate a set of conditioned perspective image data features. The processing circuitry is also configured to generate, based on the positional encoding model, the set of conditioned BEV position data features, and the set of conditioned perspective image data features, a weighted summation. The weighted summation may indicate a first relative importance of the image data for indicating characteristics of a 3D environment and a second relative importance of the position data for indicating characteristics of the 3D environment. Additionally, the processing circuitry is configured to generate, based on the weighted summation, a set of BEV image data features.
Clause 2—The system of Clause 1, wherein the positional encoding model represents a first positional encoding model, wherein the set of conditioned perspective image data features represent a first set of conditioned perspective image data features, and wherein the processing circuitry is further configured to: apply, based on a second positional encoding model, a third feature conditioning module to the set of perspective image data features to generate a second set of conditioned perspective image data features; and generate the set of BEV image data features based on the weighted summation, the set of perspective image data features, and the second set of conditioned perspective image data features.
Clause 3—The system of Clause 2, wherein the processing circuitry is further configured to: combine the second set of conditioned perspective image data features and the set of perspective image data features to form combined features; and generate the set of BEV image data features based on the weighted summation and the combined features.
Clause 4—The system of any of Clauses 2-3, wherein to generate the set of BEV image data features, the processing circuitry is configured to: apply a self-attention block to the set of perspective image data features and the second set of conditioned perspective image data features to generate a first projection output; and apply a cross-attention block to the first projection output and the weighted summation to generate a second projection output comprising the set of BEV image data features.
Clause 5—The system of Clause 4, wherein to apply the self-attention block to the set of perspective image data features and the second set of conditioned perspective image data features to generate a first projection output, the processing circuitry is configured to cause the self-attention block to: receive a set of values based on the set of perspective image data features and the second set of conditioned perspective image data features; receive a set of keys based on the set of perspective image data features and the second set of conditioned perspective image data features; receive a set of queries based on the set of perspective image data features and the second set of conditioned perspective image data features; and generate the first projection output based on the set of values, the set of keys, and the set of queries.
Clause 6—The system of any of Clauses 4-5, wherein to apply the cross-attention block to the first projection output and the weighted summation to generate the second projection output, the processing circuitry is configured to cause the cross-attention block to: receive a set of values based on the first projection output; receive a set of keys based on the first projection output; receive a set of queries based on the weighted summation; and generate the second projection output based on the set of values, the set of keys, and the set of queries.
Clause 7—The system of any of Clauses 1-6, wherein to generate the weighted summation, the processing circuitry is configured to: identify, based on the positional encoding model, the conditioned BEV position data features, and the conditioned perspective image data features, a first weight value corresponding to the conditioned BEV position data features, wherein the first weight value corresponds to the second relative importance; identify, based on the positional encoding model, the conditioned BEV position data features, and the conditioned perspective image data features, a second weight value corresponding to the conditioned perspective image data features, wherein the second weight value corresponds to the first relative importance; and generate the weighted summation based on the first weight value and the second weight value.
Clause 8—The system of any of Clauses 1-7, wherein the processing circuitry is further configured to: apply a first encoder to extract, from the image data, the set of perspective image data features; apply a second encoder to extract, from the position data, a set of 3D position data features; and compress the set of 3D position data features to generate the set of BEV position data features.
Clause 9—The system of any of Clauses 1-8, wherein the processing circuitry is further configured to: fuse the set of BEV position data features and the set of BEV image data features to generate a fused set of BEV features; and generate an output based on the fused set of BEV features.
Clause 10—The system of Clause 9, wherein to generate the output based on the fused set of BEV features, the processing circuitry is configured to: apply, to the output, a first decoder to generate a set of 3D bounding boxes that indicate a shape of one or more objects within the 3D environment; and apply, to the output, a second decoder to generate a 2D representation of the 3D environment from a perspective above the one or more objects looking down at the one or more objects.
Clause 11—The system of any of Clauses 1-10, wherein the processing circuitry and the memory are part of an advanced driver assistance system (ADAS).
Clause 12—The system of any of Clauses 1-11, wherein the processing circuitry is configured to use an output generated based on the set of BEV image data features and the set of conditioned BEV position data features to control a vehicle.
Clause 13—The system of any of Clauses 1-12, wherein the image data corresponds to one or more camera images, and wherein the position data comprises LiDAR data.
Clause 14—The system of Clause 13, wherein the apparatus further comprises: one or more cameras configured to capture the one or more camera images; and a LiDAR system configured to capture the LiDAR data.
Clause 15—A method comprising: applying, based on a positional encoding model, a first feature conditioning module to a set of BEV position data features corresponding to position data to generate a set of conditioned BEV position data features; applying, based on the position encoding model, a second feature conditioning module to a set of perspective image data features corresponding to image data to generate a set of conditioned perspective image data features; generating, based on the positional encoding model, the set of conditioned BEV position data features, and the set of conditioned perspective image data features, a weighted summation indicating a first relative importance of the image data for indicating characteristics of a 3D environment and a second relative importance of the position data for indicating characteristics of the 3D environment; and generating, based on the weighted summation, a set of BEV image data features.
Clause 16—The method of clause 15, wherein the positional encoding model represents a first positional encoding model, wherein the set of conditioned perspective image data features represent a first set of conditioned perspective image data features, and wherein the method further comprises: applying, based on a second positional encoding model, a third feature conditioning module to the set of perspective image data features to generate a second set of conditioned perspective image data features; and generating the set of BEV image data features based on the weighted summation, the set of perspective image data features, and the second set of conditioned perspective image data features.
Clause 17—The method of clause 16, further comprising: combining the second set of conditioned perspective image data features and the set of perspective image data features to form combined features; and generating the set of BEV image data features based on the weighted summation and the combined features.
Clause 18—The method of any of clauses 16-17, wherein generating the set of BEV image data features comprises: applying a self-attention block to the set of perspective image data features and the second set of conditioned perspective image data features to generate a first projection output; and applying a cross-attention block to the first projection output and the weighted summation to generate a second projection output comprising the set of BEV image data features.
Clause 19—The method of clause 18, wherein applying the self-attention block to the set of perspective image data features and the second set of conditioned perspective image data features to generate a first projection output comprises causing the self-attention block to: receive a set of values based on the set of perspective image data features and the second set of conditioned perspective image data features; receive a set of keys based on the set of perspective image data features and the second set of conditioned perspective image data features; receive a set of queries based on the set of perspective image data features and the second set of conditioned perspective image data features; and generate the first projection output based on the set of values, the set of keys, and the set of queries.
Clause 20—The method of any of clauses 18-19, wherein applying the cross-attention block to the first projection output and the weighted summation to generate the second projection output comprises causing the cross-attention block to: receive a set of values based on the first projection output; receive a set of keys based on the first projection output; receive a set of queries based on the weighted summation; and generate the second projection output based on the set of values, the set of keys, and the set of queries.
Clause 21—The method of any of clauses 15-20, wherein generating the weighted summation comprises: identifying, based on the positional encoding model, the conditioned BEV position data features, and the conditioned perspective image data features, a first weight value corresponding to the conditioned BEV position data features, wherein the first weight value corresponds to the second relative importance; identifying, based on the positional encoding model, the conditioned BEV position data features, and the conditioned perspective image data features, a second weight value corresponding to the conditioned perspective image data features, wherein the second weight value corresponds to the first relative importance; and generating the weighted summation based on the first weight value and the second weight value.
Clause 22—The method of any of clauses 15-21, further comprises: applying a first encoder to extract, from the image data, the set of perspective image data features; applying a second encoder to extract, from the position data, a set of 3D position data features; and compressing the set of 3D position data features to generate the set of BEV position data features.
Clause 23—The method of any of clauses 15-22, further comprising: fusing the set of BEV position data features and the set of BEV image data features to generate a fused set of BEV features; and generating an output based on the fused set of BEV features.
Clause 24—The method of clause 23, wherein generating the output based on the fused set of BEV features comprises: applying, to the output, a first decoder to generate a set of 3D bounding boxes that indicate a shape of one or more objects within the 3D environment; and applying, to the output, a second decoder to generate a 2D representation of the 3D environment from a perspective above the one or more objects looking down at the one or more objects.
Clause 25—The method of any of clauses 15-24, further comprising using an output generated based on the set of BEV image data features and the set of conditioned BEV position data features to control a vehicle.
Clause 26—The method of any of clauses 15-25, wherein the image data corresponds to one or more camera images, and wherein the position data comprises LiDAR data.
Clause 27—The method of clause 26, further comprising: capturing the one or more camera images using one or more cameras; and capturing the LiDAR data using a LiDAR system.
Clause 28—A computer-readable medium storing instructions that, when applied by processing circuitry, causes the processing circuitry to: apply, based on a positional encoding model, a first feature conditioning module to a set of BEV position data features corresponding to position data to generate a set of conditioned BEV position data features; apply, based on the position encoding model, a second feature conditioning module to a set of perspective image data features corresponding to image data to generate a set of conditioned perspective image data features; generate, based on the positional encoding model, the set of conditioned BEV position data features, and the set of conditioned perspective image data features, a weighted summation indicating a first relative importance of the image data for indicating characteristics of a 3D environment and a second relative importance of the position data for indicating characteristics of the 3D environment; and generate, based on the weighted summation, a set of BEV image data features.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing image data and position data, the apparatus comprising:
a memory for storing the image data and the position data; and
processing circuitry in communication with the memory, wherein the processing circuitry is configured to:
apply, based on a positional encoding model, a first feature conditioning module to a set of bird's eye view (BEV) position data features corresponding to the position data to generate a set of conditioned BEV position data features;
apply, based on the position encoding model, a second feature conditioning module to a set of perspective image data features corresponding to the image data to generate a set of conditioned perspective image data features;
generate, based on the positional encoding model, the set of conditioned BEV position data features, and the set of conditioned perspective image data features, a weighted summation indicating a first relative importance of the image data for indicating characteristics of a three-dimensional (3D) environment and a second relative importance of the position data for indicating characteristics of the 3D environment; and
generate, based on the weighted summation, a set of BEV image data features.

2. The apparatus of claim 1, wherein the positional encoding model represents a first positional encoding model, wherein the set of conditioned perspective image data features represent a first set of conditioned perspective image data features, and wherein the processing circuitry is further configured to:
apply, based on a second positional encoding model, a third feature conditioning module to the set of perspective image data features to generate a second set of conditioned perspective image data features; and
generate the set of BEV image data features based on the weighted summation, the set of perspective image data features, and the second set of conditioned perspective image data features.

3. The apparatus of claim 2, wherein the processing circuitry is further configured to:
combine the second set of conditioned perspective image data features and the set of perspective image data features to form combined features; and
generate the set of BEV image data features based on the weighted summation and the combined features.

4. The apparatus of claim 2, wherein to generate the set of BEV image data features, the processing circuitry is configured to:
apply a self-attention block to the set of perspective image data features and the second set of conditioned perspective image data features to generate a first projection output; and
apply a cross-attention block to the first projection output and the weighted summation to generate a second projection output comprising the set of BEV image data features.

5. The apparatus of claim 4, wherein to apply the self-attention block to the set of perspective image data features and the second set of conditioned perspective image data features to generate a first projection output, the processing circuitry is configured to cause the self-attention block to:
receive a set of values based on the set of perspective image data features and the second set of conditioned perspective image data features;
receive a set of keys based on the set of perspective image data features and the second set of conditioned perspective image data features;
receive a set of queries based on the set of perspective image data features and the second set of conditioned perspective image data features; and
generate the first projection output based on the set of values, the set of keys, and the set of queries.

6. The apparatus of claim 4, wherein to apply the cross-attention block to the first projection output and the weighted summation to generate the second projection output, the processing circuitry is configured to cause the cross-attention block to:
receive a set of values based on the first projection output;
receive a set of keys based on the first projection output;
receive a set of queries based on the weighted summation; and
generate the second projection output based on the set of values, the set of keys, and the set of queries.

7. The apparatus of claim 1, wherein to generate the weighted summation, the processing circuitry is configured to:
identify, based on the positional encoding model, the conditioned BEV position data features, and the conditioned perspective image data features, a first weight value corresponding to the conditioned BEV position data features, wherein the first weight value corresponds to the second relative importance;
identify, based on the positional encoding model, the conditioned BEV position data features, and the conditioned perspective image data features, a second weight value corresponding to the conditioned perspective image data features, wherein the second weight value corresponds to the first relative importance; and
generate the weighted summation based on the first weight value and the second weight value.

8. The apparatus of claim 1, wherein the processing circuitry is further configured to:
apply a first encoder to extract, from the image data, the set of perspective image data features;
apply a second encoder to extract, from the position data, a set of 3D position data features; and
compress the set of 3D position data features to generate the set of BEV position data features.

9. The apparatus of claim 1, wherein the processing circuitry is further configured to:
fuse the set of BEV position data features and the set of BEV image data features to generate a fused set of BEV features; and
generate an output based on the fused set of BEV features.

10. The apparatus of claim 9, wherein to generate the output based on the fused set of BEV features, the processing circuitry is configured to:
apply, to the output, a first decoder to generate a set of 3D bounding boxes that indicate a shape of one or more objects within the 3D environment; and
apply, to the output, a second decoder to generate a two-dimensional (2D) representation of the 3D environment from a perspective above the one or more objects looking down at the one or more objects.

11. The apparatus of claim 1, wherein the processing circuitry and the memory are part of an advanced driver assistance system (ADAS).

12. The apparatus of claim 1, wherein the processing circuitry is configured to use an output generated based on the set of BEV image data features and the set of conditioned BEV position data features to control a vehicle.

13. The apparatus of claim 1, wherein the image data corresponds to one or more camera images, and wherein the position data comprises Light Detection and Ranging (LiDAR) data.

14. The apparatus of claim 13, wherein the apparatus further comprises:
one or more cameras configured to capture the one or more camera images; and
a LiDAR system configured to capture the LiDAR data.

15. A method comprising:
applying, based on a positional encoding model, a first feature conditioning module to a set of bird's eye view (BEV) position data features corresponding to position data to generate a set of conditioned BEV position data features;
applying, based on the position encoding model, a second feature conditioning module to a set of perspective image data features corresponding to image data to generate a set of conditioned perspective image data features;
generating, based on the positional encoding model, the set of conditioned BEV position data features, and the set of conditioned perspective image data features, a weighted summation indicating a first relative importance of image data for indicating characteristics of a three-dimensional (3D) environment and a second relative importance of position data for indicating characteristics of the 3D environment; and
generating, based on the weighted summation, a set of BEV image data features.

16. The method of claim 15, wherein the positional encoding model represents a first positional encoding model, wherein the set of conditioned perspective image data features represent a first set of conditioned perspective image data features, and wherein the method further comprises:
applying, based on a second positional encoding model, a third feature conditioning module to the set of perspective image data features to generate a second set of conditioned perspective image data features; and
generating the set of BEV image data features based on the weighted summation, the set of perspective image data features, and the second set of conditioned perspective image data features.

17. The method of claim 16, further comprising:
combining the second set of conditioned perspective image data features and the set of perspective image data features to form combined features; and
generating the set of BEV image data features based on the weighted summation and the combined features.

18. The method of claim 16, wherein generating the set of BEV image data features comprises:
applying a self-attention block to the set of perspective image data features and the second set of conditioned perspective image data features to generate a first projection output; and
applying a cross-attention block to the first projection output and the weighted summation to generate a second projection output comprising the set of BEV image data features.

19. The method of claim 18, wherein applying the self-attention block to the set of perspective image data features and the second set of conditioned perspective image data features to generate a first projection output comprises causing the self-attention block to:
receive a set of values based on the set of perspective image data features and the second set of conditioned perspective image data features;
receive a set of keys based on the set of perspective image data features and the second set of conditioned perspective image data features;
receive a set of queries based on the set of perspective image data features and the second set of conditioned perspective image data features; and
generate the first projection output based on the set of values, the set of keys, and the set of queries.

20. The method of claim 18, wherein applying the cross-attention block to the first projection output and the weighted summation to generate the second projection output comprises causing the cross-attention block to:
receive a set of values based on the first projection output;
receive a set of keys based on the first projection output;
receive a set of queries based on the weighted summation; and
generate the second projection output based on the set of values, the set of keys, and the set of queries.

21. The method of claim 15, wherein generating the weighted summation comprises:
identifying, based on the positional encoding model, the conditioned BEV position data features, and the conditioned perspective image data features, a first weight value corresponding to the conditioned BEV position data features, wherein the first weight value corresponds to the second relative importance;
identifying, based on the positional encoding model, the conditioned BEV position data features, and the conditioned perspective image data features, a second weight value corresponding to the conditioned perspective image data features, wherein the second weight value corresponds to the first relative importance; and
generating the weighted summation based on the first weight value and the second weight value.

22. The method of claim 15, further comprises:
applying a first encoder to extract, from the image data, the set of perspective image data features;
applying a second encoder to extract, from the position data, a set of 3D position data features; and
compressing the set of 3D position data features to generate the set of BEV position data features.

23. The method of claim 15, further comprising:
fusing the set of BEV position data features and the set of BEV image data features to generate a fused set of BEV features; and
generating an output based on the fused set of BEV features.

24. The method of claim 23, wherein generating the output based on the fused set of BEV features comprises:
applying, to the output, a first decoder to generate a set of 3D bounding boxes that indicate a shape of one or more objects within the 3D environment; and
applying, to the output, a second decoder to generate a two-dimensional (2D) representation of the 3D environment from a perspective above the one or more objects looking down at the one or more objects.

25. The method of claim 15, further comprising using an output generated based on the set of BEV image data features and the set of conditioned BEV position data features to control a vehicle.

26. The method of claim 15, wherein the image data corresponds to one or more camera images, and wherein the position data comprises Light Detection and Ranging (LiDAR) data.

27. The method of claim 26, further comprising:
capturing the one or more camera images using one or more cameras; and
capturing the LiDAR data using a LiDAR system.

28. A computer-readable medium storing instructions that, when applied by processing circuitry, causes the processing circuitry to:
apply, based on a positional encoding model, a first feature conditioning module to a set of bird's eye view (BEV) position data features corresponding to position data to generate a set of conditioned BEV position data features;
apply, based on the position encoding model, a second feature conditioning module to a set of perspective image data features corresponding to image data to generate a set of conditioned perspective image data features;
generate, based on the positional encoding model, the set of conditioned BEV position data features, and the set of conditioned perspective image data features, a weighted summation indicating a first relative importance of the image data for indicating characteristics of a three-dimensional (3D) environment and a second relative importance of the position data for indicating characteristics of the 3D environment; and
generate, based on the weighted summation, a set of BEV image data features.
